(19) United States
(12) Patent Application Publication
(10) Pub. No.: US 2025/0310999 A1
(43) Pub. Date: Oct. 2, 2025

(54) COORDINATED TIME OVERLAPPED CHANNEL ACCESS

(71) Applicant: Senscomm Semiconductor Co., Ltd., Suzhou (CN)

(72) Inventors: Sung Jin PARK, Seoul (KR); Daehong KIM, Laguna Hills, CA (US)

(21) Appl. No.: 19/091,692

(22) Filed: Mar. 26, 2025

Related U.S. Application Data
(60) Provisional application No. 63/571,713, filed on Mar. 29, 2024.
(60) Provisional application No. 63/766,174, filed on Mar. 3, 2025.

(30) Foreign Application Priority Data
Mar. 21, 2025 (CN) 202510343546.5

(51) Int. Cl. H04W 74/0816; H04B 17/309; H04W 28/02; H04W 74/08

(52) U.S. Cl. CPC H04W 74/0816; H04B 17/346; H04W 28/0278; H04W 74/0875

(57) ABSTRACT

A first access point (AP) for facilitating communication in a wireless network. The first AP includes a memory and a processor. The first AP obtains a transmission opportunity (TXOP) on a wireless channel. The first AP transmits, to a plurality stations (STAs), a control frame that requests buffer status information. The first AP receives, from at least two STAs, response frames, each response frame including a buffer status report associated with a respective STA. The first AP determines two or more candidate STAs for allocation of a portion of the TXOP based on the buffer status report in each response frame. The first AP determines whether estimated interference between the two or more candidate STAs is smaller than a predetermined level. The first AP transmits, to the two or more candidate STAs, a frame that allocates a portion of the obtained TXOP based on the determination regarding the estimated interference.

### CROSS REFERENCE TO RELATED APPLICATION

This application claims benefit of U.S. Provisional Application No. 63/571,713 filed on Mar. 29, 2024 and U.S. Provisional Application No. 63/766,174 filed on Mar. 3, 2025 in the United States Patent and Trademark Office, and China Patent Application No. 202510343546.5 filed on Mar. 21, 2025, in the China National Intellectual Property Administration, the entire contents of which are hereby incorporated by reference.

### TECHNICAL FIELD

This disclosure relates generally to a wireless communication system, and more particularly to, for example, but not limited to, transmission opportunity (TXOP) sharing in wireless networks.

### BACKGROUND

Wireless local area network (WLAN) devices are widely deployed in diverse environments to provide various communication services such as video, cloud access, broadcasting and offloading. Some of these environments have a lot of access points (AP) stations and non-AP stations in geographically limited areas. The WLAN technology has evolved toward increasing data rates and continues its growth in various markets such as home, enterprise and hotspots over the years since the late 1990s. Recently released standard (IEEE 802.11ax-2021) provides improved network performance in the high-density scenario by adopting OFDMA and MU-MIMO technologies. These improvements can be used to support environments such as outdoor hotspots, dense residential/office area, and stadiums.

The Wi-Fi system has a transmission opportunity (TXOP) sharing framework. The TXOP sharing may allow an access point (AP) station (STA) to allocate time within an obtained TXOP to an associated non-AP STA. The non-AP STA to which time is allocated by the AP may transmit uplink (UL) data without receiving a trigger frame from the AP and may communicate peer-to-peer with other non-AP STAs within the same basic service set (BSS).

However, since the existing TXOP sharing enables the AP to allocate time resources to only one STA, it can limit traffic throughput. Moreover, it is inefficient in terms of channel utilization as it only allocates time without considering the available frequency resources.

The description set forth in the background section should not be assumed to be prior art merely because it is set forth in the background section. The background section may describe aspects or embodiments of the present disclosure.

### SUMMARY

This disclosure may be directed to improvements to a wireless communications system, more particularly to provide a mechanism and procedure for transmission opportunity (TXOP) sharing which may be used to perform time-overlapped channel access.

An aspect of the disclosure provides a first access point (AP) for facilitating communication in a wireless network. The first AP comprises a memory and a processor coupled to the memory. The processor is configured to cause obtaining a transmission opportunity (TXOP) on a wireless channel. The processor is further configured to transmitting, to a plurality of stations (STAs), a control frame that requests buffer status information. The processor is further configured to cause receiving, from at least two STAs, response frames, each response frame including a buffer status report associated with a respective STA. The processor is further configured to cause determining two or more candidate STAs for allocation of a portion of the TXOP based on the buffer status report in each response frame. The processor is further configured to cause determining whether estimated interference between the two or more candidate STAs is smaller than a predetermined level. The processor is further configured to cause transmitting, to the two or more candidate STAs, a frame that allocates a portion of the obtained TXOP based on a determination that the estimated interference is smaller than the predetermined level.

In an embodiment, the control frame further requests information associated with a presence of latency-sensitive traffic. Each response frame further includes an indication of the presence of latency-sensitive traffic. The two or more candidate STAs are determined based on the buffer status report and the presence of latency-sensitive traffic in each response frame.

In an embodiment, the determining two or more candidate STAs comprising prioritizing a STA having latency-sensitive traffic.

In an embodiment, the determining two or more candidate STAs comprising prioritizing a STA having a large volume of traffic in a buffer.

In an embodiment, each response frame includes information about a destination STA of traffic stored in the buffer.

In an embodiment, each of the two or more second STAs is either a non-AP STA or an AP.

In an embodiment, the two or more candidate STAs include one or more second APs. The first AP and the one or more second APs participate in a multi-AP coordination. The first AP is a sharing AP and the one or more second APs are sharing APs.

In an embodiment, the two or more candidate STAs are determined based on the estimated interference and an interference condition.

In an embodiment, the interference condition includes at least one of signal strength, relative position or previous interference level of each candidate STA.

In an embodiment, the two or more candidate STAs are allowed to simultaneously transmit and receive one or more frames during the allocated TXOP.

An aspect of the disclosure provides a method performed by an access point. The method comprises obtaining a transmission opportunity (TXOP) on a wireless channel. The method further comprises transmitting, to a plurality of stations (STAs), a control frame that requests buffer status information. The method further comprises receiving, from at least two STAs, response frames, each response frame including a buffer status report associated with a respective STA. The method further comprises determining two or more candidate STAs for allocation of a portion of the TXOP based on the buffer status report in each response frame. The method further comprises determining whether estimated interference between the two or more candidate STAs is smaller than a predetermined level. The method further comprises transmitting, to the two or more candidate STAs, a frame that allocates a portion of the obtained TXOP based on a determination that the estimated interference is smaller than the predetermined level.

In an embodiment, the control frame further requests information associated with a presence of latency-sensitive traffic. Each response frame further includes an indication of the presence of latency-sensitive traffic. The two or more candidate STAs are determined based on the buffer status report and the presence of latency-sensitive traffic in each response frame.

In an embodiment, the determining two or more candidate STAs comprising prioritizing a STA having latency-sensitive traffic.

In an embodiment, the determining two or more candidate STAs comprising prioritizing a STA having a large volume of traffic in a buffer.

In an embodiment, each response frame includes information about a destination STA of traffic stored in the buffer.

In an embodiment, each of the two or more second STAs is either a non-AP STA or an AP.

In an embodiment, the two or more candidate STAs include one or more second APs. The first AP and the one or more second APs participate in a multi-AP coordination. The first AP is a sharing AP and the one or more second APs are sharing APs.

In an embodiment, the two or more candidate STAs are determined based on the estimated interference and an interference condition.

In an embodiment, the interference condition includes at least one of signal strength, relative position or previous interference level of each candidate STA.

In an embodiment, the two or more candidate STAs are allowed to simultaneously transmit and receive one or more frames during the allocated TXOP.

### BRIEF DESCRIPTION OF THE DRAWINGS

FIG. 1 shows a schematic diagram of an example wireless communication network.

FIG. 2 shows an example of a timing diagram of interframe space (IFS) relationships between wireless devices in accordance with an embodiment.

FIG. 3 shows an OFDM symbol and an OFDMA symbol in accordance with an embodiment.

FIG. 4A shows the EHT MU PPDU format in accordance with an embodiment.

FIG. 4B shows the EHT TB PPDU format in accordance with an embodiment.

FIG. 5 shows a block diagram of an electronic device for facilitating wireless communication in accordance with an embodiment.

FIG. 6 shows a schematic diagram of an example of a transmitter in accordance with an embodiment.

FIG. 7 shows a schematic diagram of an example of a receiver in accordance with an embodiment.

FIG. 8 shows an example BSS formed by an AP and its associated STAs in accordance with an embodiment.

FIG. 9 shows an example BSS and OBSS formed by a sharing AP and its associated STA and a shared AP and its associated STA, respectively, in accordance with an embodiment.

FIG. 10 shows an example TXOP sharing from the sharing AP with multiple STAs simultaneously in accordance with an embodiment.

FIG. 11 shows an example TXOP sharing from the sharing AP with a STA in the sharing AP's BSS and a shared AP in accordance with an embodiment.

FIG. 12 shows an example TXOP sharing process for allocating time resources in accordance with an embodiment.

FIG. 13 shows another example TXOP sharing process for allocating time resources in accordance with an embodiment.

FIG. 14 shows yet another example TXOP sharing process for allocating time resources in accordance with and embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The detailed description set forth below is intended to describe various implementations and is not intended to represent the only implementation. As those skilled in the art would realize, the described implementations may be modified in various different ways, all without departing from the scope of the present disclosure. Accordingly, the drawings and description are to be regarded as illustrative in nature and not restrictive. Like reference numerals designate like elements.

The below detailed description herein has been described with reference to a wireless LAN system according to the Institute of Electrical and Electronics Engineers (IEEE) 802.11 wireless standards including the current and future amendments. However, a person having ordinary skill in the art will readily recognize that the teachings herein are applicable to other network environments, such as cellular telecommunication networks and wired telecommunication networks.

In an embodiment, apparatus or devices such as an AP STA and a non-AP may include one or more hardware and software logic structure for performing one or more of the operations described herein. For example, the apparatuses or devices may include at least one memory unit which stores instructions that may be executed by a hardware processor installed in the apparatus and at least one processor which is configured to perform operations or processes described in the disclosure. The apparatus may also include one or more other hardware or software elements such as a network interface and a display device.

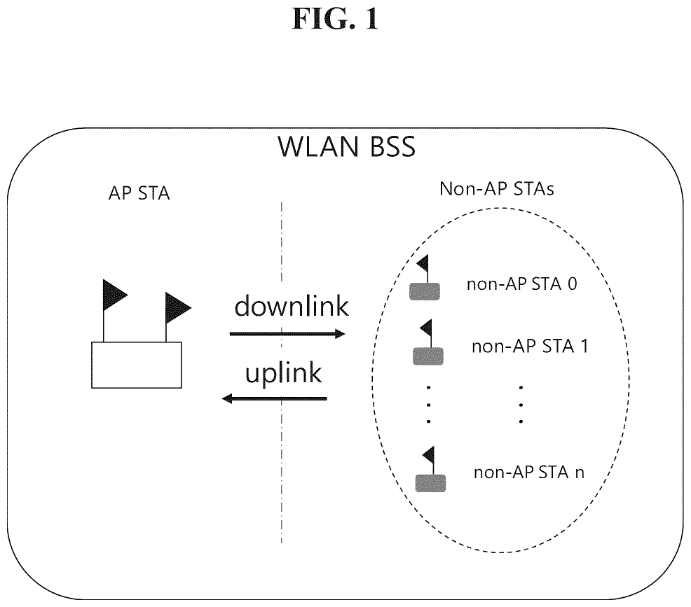

FIG. 1 shows a schematic diagram of an example wireless communication network.

Referring to FIG. 1, a basic service set (BSS) 10 may include a plurality of stations (STAs) including an access point (AP) station (AP STA) 11 and one or more non-AP station (non-AP STA) 12. For convenience, the non-AP STA may be referred to interchangeably as a user or an STA. The STAs may share a same radio frequency channel with one out of WLAN operation bandwidth options (e.g., 20/40/80/160/320 MHz). Hereinafter, in an embodiment, the AP STA and the non-AP STA may be referred as AP and STA, respectively. In an embodiment, the AP STA and the non-AP STA may be collectively referred as station (STA).

The plurality of STAs may participate in multi-user (MU) transmission. In the MU transmission, the AP STA 11 may simultaneously transmit the downlink (DL) frames to the multiple non-AP STAs 12 in the BSS 10 based on different resources and the multiple non-AP STAs 12 may simultaneously transmit the uplink (UL) frames to the AP STA 11 in the BSS 10 based on different resources.

For the MU transmission, multi-user multiple input, multiple output (MU-MIMO) transmission or orthogonal frequency division multiple access (OFDMA) transmission may be used. In MU-MIMO transmission, with one or more antennas, the multiple non-AP STAs 12 may either simultaneously transmit to the AP STA 11 or simultaneously receive from the AP STA 11 independent data streams over the same subcarriers. Different frequency resources may be used as the different resources in the MU-MIMO transmission. In OFDMA transmission, the multiple non-AP STAs 12 may either simultaneously transmit to the AP STA 11 or simultaneously receive from the AP STA 11 independent data streams over different groups of subcarriers. Different spatial streams may be used as the different resources in MU-MIMO transmission.

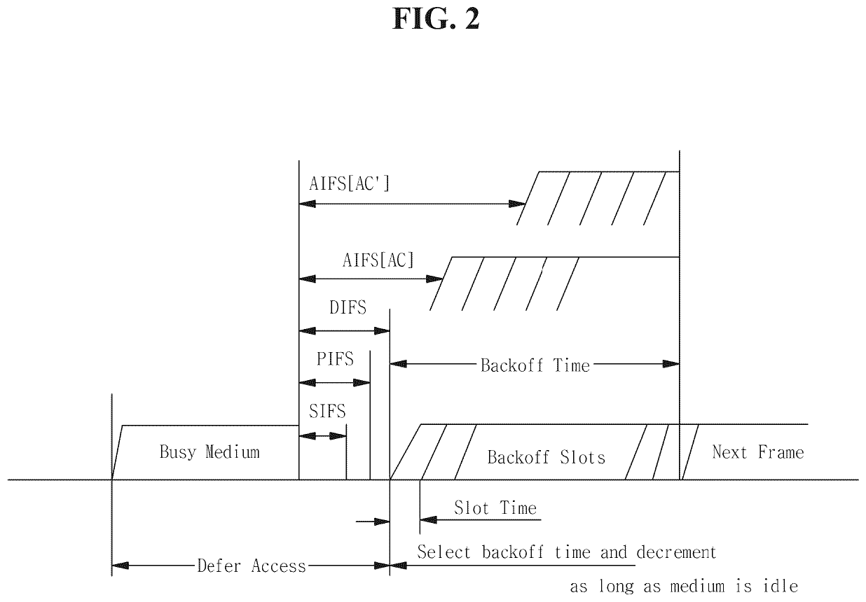

FIG. 2 shows an example of a timing diagram of interframe space (IFS) relationships between stations in accordance with an embodiment.

In particular, FIG. 2 shows a CSMA (carrier sense multiple access)/CA (collision avoidance) based frame transmission procedure for avoiding collision between frames in a channel.

A data frame, a control frame, or a management frame may be exchanged between STAs.

The data frame may be used for transmission of data forwarded to a higher layer. Referring to FIG. 2, access is deferred while the medium is busy until a type of IFS duration has elapsed. The STA may transmit the data frame after performing backoff if a distributed coordination function IFS (DIFS) has elapsed from a time when the medium has been idle.

The management frame may be used for exchanging management information which is not forwarded to the higher layer. Subtype frames of the management frame may include a beacon frame, an association request/response frame, a probe request/response frame, and an authentication request/response frame.

The control frame may be used for controlling access to the medium. Subtype frames of the control frame include a request to send (RTS) frame, a clear to send (CTS) frame, and an acknowledgement (ACK) frame. In the case that the control frame is not a response frame of the other frame, the STA may transmit the control frame after performing backoff if the DIFS has elapsed. If the control frame is the response frame of a previous frame, the WLAN device may transmit the control frame without performing backoff when a short IFS (SIFS) has elapsed. The type and subtype of frame may be identified by a type field and a subtype field in a frame control field.

On the other hand, a Quality of Service (QOS) STA may transmit the frame after performing backoff if an arbitration IFS (AIFS) for access category (AC), i.e., AIFS [AC] has elapsed. In this case, the data frame, the management frame, or the control frame which is not the response frame may use the AIFC[AC].

In an embodiment, a point coordination function (PCF) enabled AP STA may transmit the frame after performing backoff if a PCF IFS (PIFS) has elapsed. The PIFS duration may be less than the DIFS but greater than the SIFS.

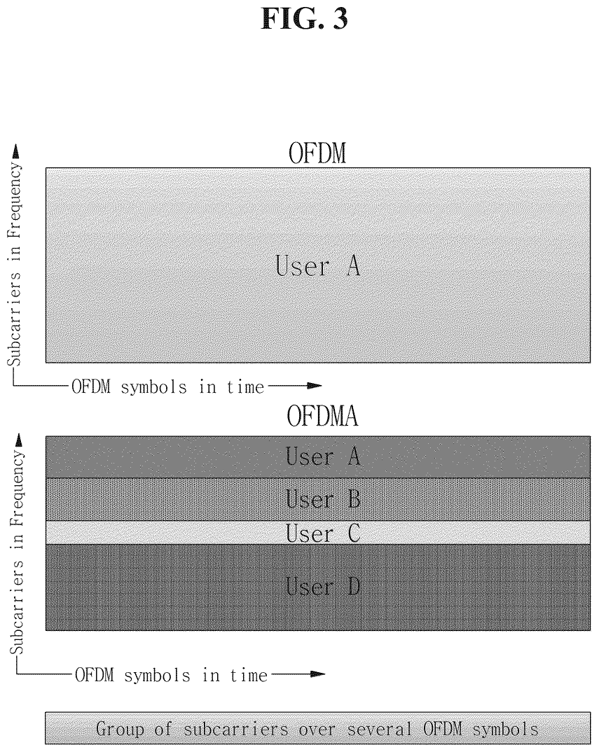

FIG. 3 shows an OFDM symbol and an OFDMA symbol in accordance with an embodiment.

For multi-user access modulation, the orthogonal frequency division multiple access (OFDMA) for uplink and downlink has been introduced in IEEE 802.11ax standard known as High Efficiency (HE) WLAN and will be used in 802.11's future amendments such as EHT (Extreme High Throughput). One or more STAs may be allowed to use one or more resource units (RUs) throughout operation bandwidth to transmit data at the same time. As the minimum granularity, one RU may comprise a group of predefined number of subcarriers and be located at predefined location in orthogonal frequency division multiplexing (OFDM) modulation symbol. Here, non-AP STAs may be associated or non-associated with AP STA when responding simultaneously in the assigned RUs within a specific period such as a short inter frame space (SIFS). The SIFS may refer to the time duration from the end of the last symbol, or signal extension if present, of the previous frame to the beginning of the first symbol of the preamble of the subsequent frame.

The OFDMA is an OFDM-based multiple access scheme where different subsets of subcarriers may be allocated to different users, allowing simultaneous data transmission to or from one or more users with high accurate synchronization for frequency orthogonality. In OFDMA, users may be allocated different subsets of subcarriers which can change from one physical layer (PHY) protocol data unit (PPDU) to the next. In OFDMA, an OFDM symbol is constructed of subcarriers, the number of which is a function of the PPDU bandwidth. The difference between OFDM and OFDMA is illustrated in FIG. 3.

In a case of UL MU transmission, given different STAs with their own capabilities and features, the AP STA may want to have more control mechanism of the medium by using more scheduled access, which may allow more frequent use of OFDMA/MU-MIMO transmissions. PPDUs in UL MU transmission (MU-MIMO or OFDMA) may be sent as a response to the trigger frame sent by the AP. The trigger frame may have STA's information and assign RUs and multiple RUs (MRUs) to STAs. The STA's information in the trigger frame may comprise STA Identification (ID), MCS (modulation and coding scheme), and frame length. The trigger frame may allow an STA to transmit trigger-based (TB) PPDU (e.g., HE TB PPDU or EHT TB PPDU) which is segmented into an RU and all RUs as a response of Trigger frame are allocated to the solicited non-AP STAs accordingly. Hereafter, a single RU and a multiple RU may be referred to as the RU. The multiple RU may include, or consist of, predefined two, three, or more RUs.

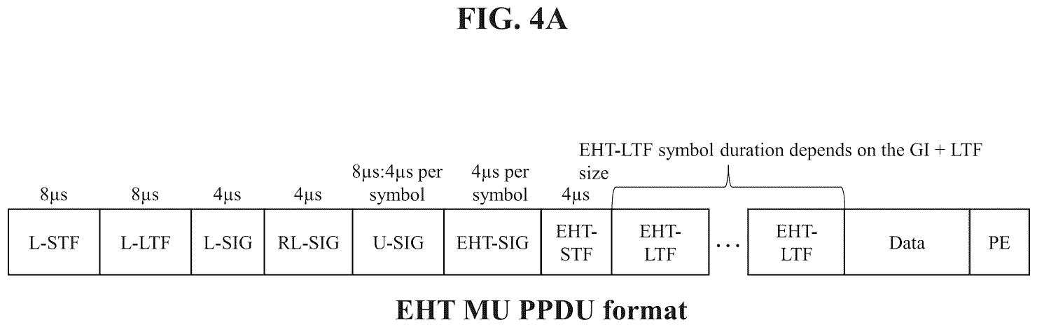

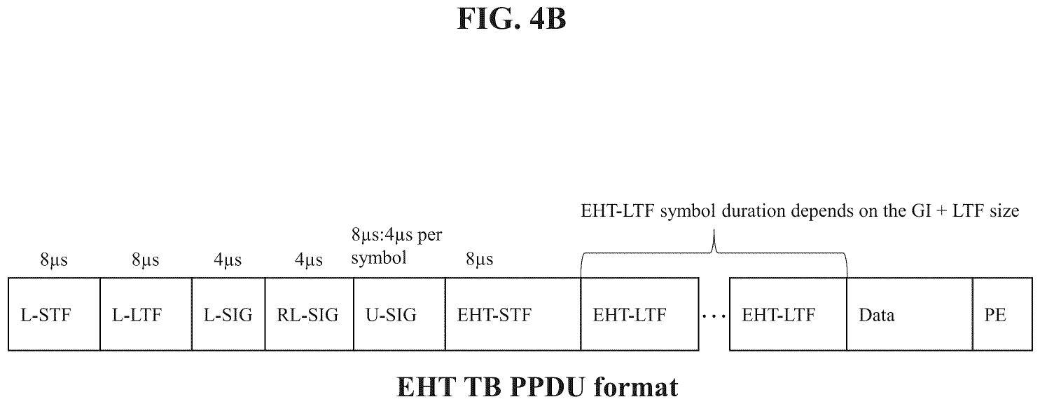

In EHT amendment, two EHT PPDU formats are defined: the EHT MU PPDU and the EHT TB PPDU. Hereinafter, the EHT MU PPDU and the EHT TB PPDU will be described with reference to FIG. 4A and FIG. 4B.

FIG. 4A shows the EHT MU PPDU format in accordance with an embodiment.

The EHT MU PPDU may be used for transmission to one or more users. The EHT MU PPDU is not a response to a triggering frame.

Referring to FIG. 4A, the EHT MU PPDU may include, or consist of, an EHT preamble (hereinafter referred to as a PHY preamble or a preamble), a data field, and a packet extension (PE) field. The EHT preamble may include, or consist of, pre-EHT modulated fields and EHT modulated fields. The pre-EHT modulated fields may include, or consist of, a Non-HT short training field (L-STF), a Non-HT long training field (L-LTF), a Non-HT signal (L-SIG) field, a repeated Non-HT signal (RL-SIG) field, a universal signal (U-SIG) field, and an EHT signal (EHT-SIG) field. The EHT modulated fields may include, or consist of, an EHT short training field (EHT-STF) and an EHT long training field (EHT-LTF). In an embodiment, the L-STF may be immediately followed by the L-LTF immediately followed by the L-SIG field immediately followed by the RL-SIG field immediately followed by the U-SIG field immediately followed by the EHT-SIG field immediately followed by the EHT-STF immediately followed by the EHT-LTF immediately followed by the data field immediately followed by the PE field.

The L-STF field may be utilized for packet detection, automatic gain control (AGC), and coarse frequency-offset correction.

The L-LTF field may be utilized for channel estimation, fine frequency-offset correction, and symbol timing.

The L-SIG field may be used to communicate rate and length information.

The RL-SIG field may be a repeat of the L-SIG field and may be used to differentiate an EHT PPDU from a non-HT PPDU, HT PPDU, and VHT PPDU.

The U-SIG field may carry information necessary to interpret EHT PPDUs.

The EHT-SIG field may provide additional signaling to the U-SIG field for STAs to interpret an EHT MU PPDU. Hereinafter, the U-SIG field, the EHT-SIG field, or both may be referred to as the SIG field.

The EHT-SIG field may include one or more EHT-SIG content channel. Each of the one or more EHT-SIG content channel may include a common field and a user specific field. The common field may contain information regarding the resource unit allocation such as the RU assignment to be used in the EHT modulated fields of the PPDU, the RUs allocated for MU-MIMO and the number of users in MU-MIMO allocations. The user specific field may include one or more user fields.

The user field for a non-MU-MIMO allocation may include a STA-ID subfield, a MCS subfield, a NSS subfield, a beamformed subfield, and a coding subfield. The user field for a MU-MIMO allocation may include a STA-ID subfield, a MCS subfield, a coding subfield, and a spatial configuration subfield.

The EHT-STF field may be used to improve automatic gain control estimation in a MIMO transmission.

The EHT-LTF field may enable the receiver to estimate the MIMO channel between the set of constellation mapper outputs and the receive chains.

The data field may carry one or more physical layer convergence procedure (PLCP) service data units (PSDUs).

The PE field may provide additional receive processing time at the end of the EHT MU PPDU.

FIG. 4B shows the EHT TB PPDU format in accordance with an embodiment.

The EHT TB PPUD may be used for a transmission of a response to a triggering frame.

Referring to FIG. 4B, the EHT TB PPDU may include, or consist of, an EHT preamble (hereinafter referred to as a PHY preamble or a preamble), a data field, and a packet extension (PE) field. The EHT preamble may include, or consist of, pre-EHT modulated fields and EHT modulated fields. The pre-EHT modulated fields may include, or consist of, a Non-HT short training field (L-STF), a Non-HT long training field (L-LTF), a Non-HT signal (L-SIG) field, a repeated Non-HT signal (RL-SIG) field, and a universal signal (U-SIG) field. The EHT modulated fields may include, or consist of, an EHT short training field (EHT-STF) and an EHT long training field (EHT-LTF). In an embodiment, the L-STF may be immediately followed by the L-LTF immediately followed by the L-SIG field immediately followed by the RL-SIG field immediately followed by the U-SIG field immediately followed by the EHT-STF immediately followed by the EHT-LTF immediately followed by the data field immediately followed by the PE field. In the EHT TB PPUD, the EHT-SIG field is not present because the trigger frame conveys necessary information and the duration of the EHT_STF field in the EHT TB PPUD is twice the duration of the EHT-STF field in the EHT MU PPDU.

Description for each field in the EHT TB PPDU will be omitted because description for each field in the EHT MU PPDU is applicable to the EHT TB PPDU.

For EHT MU PPDU and EHT TB PPUD, when the EHT modulated fields occupy more than one 20 MHz channels, the pre-EHT modulated fields may be duplicated over multiple 20 MHz channels.

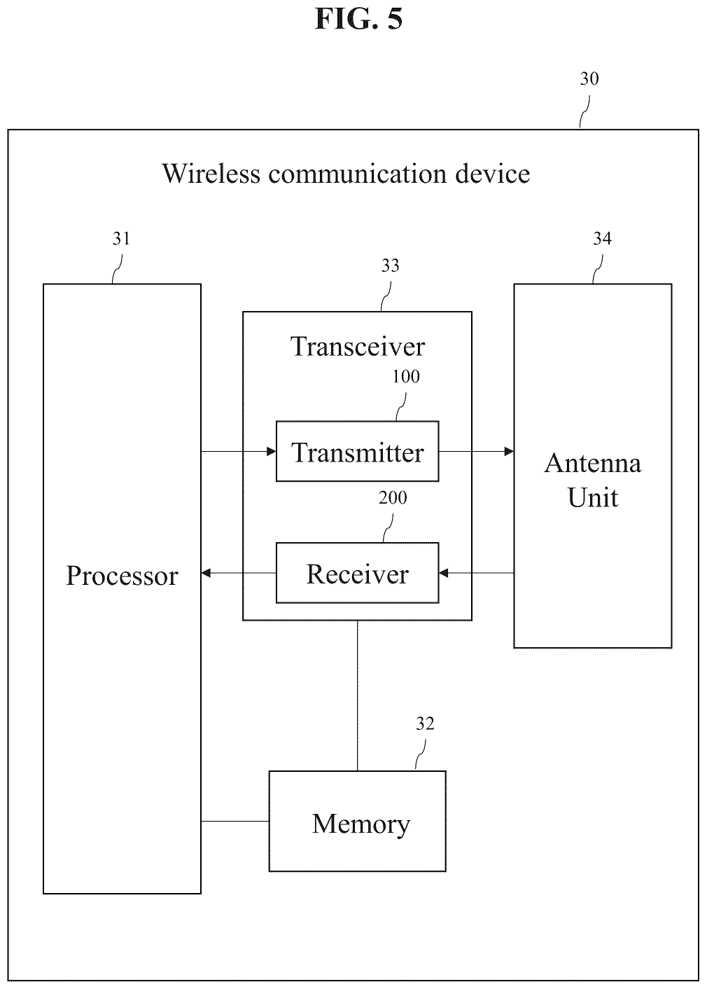

Hereinafter, electronic devices for facilitating wireless communication in accordance with various embodiments will be described with reference to FIG. 5.

FIG. 5 shows a block diagram of an electronic device for facilitating wireless communication in accordance with an embodiment.

Referring to FIG. 5, an electronic device 30 for facilitating wireless communication in accordance with an embodiment may include a processor 31, a memory 32, a transceiver 33, and an antenna unit 34. The transceiver 33 may include a transmitter 100 and a receiver 200.

The processor 31 may perform medium access control (MAC) functions, PHY functions, RF functions, or a combination of some or all of the foregoing. In an embodiment, the processor 31 may comprise some or all of a transmitter 100 and a receiver 200. The processor 31 may be directly or indirectly coupled to the memory 32. In an embodiment, the processor 31 may include one or more processors.

The memory 32 may be non-transitory computer-readable recording medium storing instructions that, when executed by the processor 31, cause the electronic device 30 to perform operations, methods or procedures set forth in the present disclosure. In an embodiment, the memory 32 may store instructions that are needed by one or more of the processor 31, the transceiver 33, and other components of the electronic device 30. The memory may further store an operating system and applications. The memory 32 may comprise, be implemented as, or be included in a read-and-write memory, a read-only memory, a volatile memory, a non-volatile memory, or a combination of some or all of the foregoing.

The antenna unit 34 includes one or more physical antennas. When multiple-input multiple-output (MIMO) or multi-user MIMO (MU-MIMO) is used, the antenna unit 34 may include more than one physical antennas.

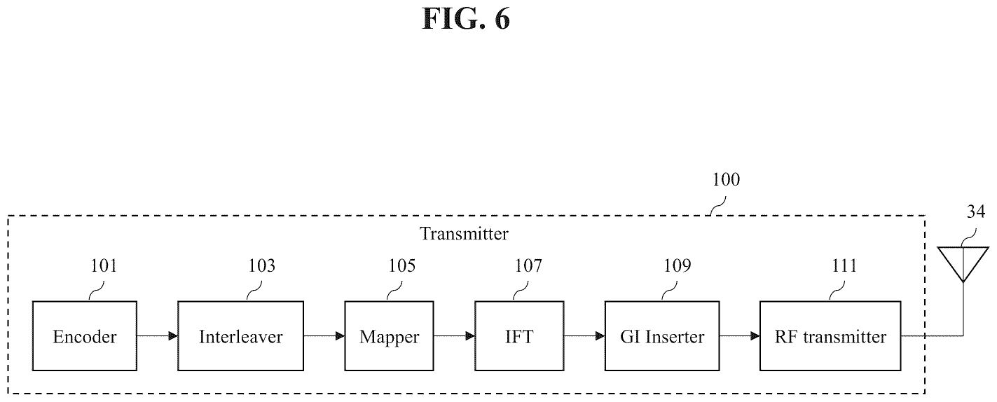

FIG. 6 shows a block diagram of a transmitter in accordance with an embodiment.

Referring to FIG. 6, the transmitter 100 may include an encoder 101, an interleaver 103, a mapper 105, an inverse Fourier transformer (IFT) 107, a guard interval (GI) inserter 109, and an RF transmitter 111.

The encoder 101 may encode input data to generate encoded data. For example, the encoder 101 may be a forward error correction (FEC) encoder. The FEC encoder may include or be implemented as a binary convolutional code (BCC) encoder, or a low-density parity-check (LDPC) encoder.

The interleaver 103 may interleave bits of encoded data from the encoder 101 to change the order of bits, and output interleaved data. In an embodiment, interleaving may be applied when BCC encoding is employed.

The mapper 105 may map interleaved data into constellation points to generate a block of constellation points. If the LDPC encoding is used in the encoder 101, the mapper 105 may further perform LDPC tone mapping instead of the constellation mapping.

The IFT 107 may convert the block of constellation points into a time domain block corresponding to a symbol by using an inverse discrete Fourier transform (IDFT) or an inverse fast Fourier transform (IFFT).

The GI inserter 109 may prepend a GI to the symbol.

The RF transmitter 111 may convert the symbols into an RF signal and transmits the RF signal via the antenna unit 34.

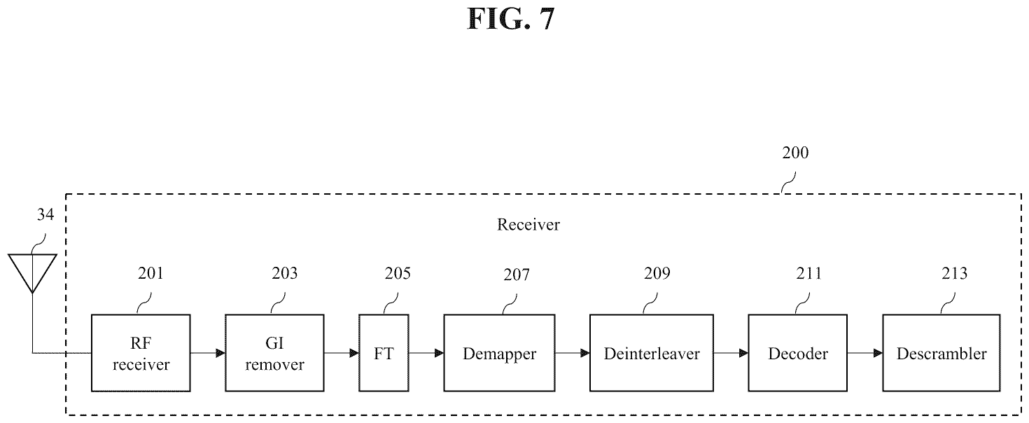

FIG. 7 shows a block diagram of a receiver in accordance with an embodiment.

Referring to FIG. 7, the receiver 200 in accordance with an embodiment may include a RF receiver 201, a GI remover 203, a Fourier transformer (FT) 205, a demapper 207, a deinterleaver 209, and a decoder 211.

The RF receiver 201 may receive an RF signal via the antenna unit 34 and converts the RF signal into one or more symbols.

The GI remover 203 may remove the GI from the symbol.

The FT 205 may convert the symbol corresponding a time domain block into a block of constellation points by using a discrete Fourier transform (DFT) or a fast Fourier transform (FFT) depending on implementation.

The demapper 207 may demap the block of constellation points to demapped data bits. If the LDPC encoding is used, the demapper 207 may further perform LDPC tone demapping before the constellation demapping.

The deinterleaver 209 may deinterleave demapped data bits to generate deinterleaved data bits. In an embodiment, deinterleaving may be applied when BCC encoding is used.

The decoder 211 may decode the deinterleaved data bits to generate decoded bits. For example, the decoder 211 may be an FEC decoder. The FEC decoder may include a BCC decoder or an LDPC decoder. In order to support the HARQ procedure, the decoder 211 may combine a retransmitted data with an initial data.

The descrambler 213 may descramble the descrambled data bits based on a scrambler seed.

Hereinafter, a multi-link operation (MLO) in accordance with an embodiment will be described.

The IEEE 802.11be Extremely High Throughput (EHT) task group is currently developing the next generation Wi-Fi standard to achieve higher data rate, lower latency, and more reliable connection to enhance user experience. One of the key features of the IEEE 802.11be standard is a multi-link operation (MLO). As most of the AP STAs and the non-AP STAs incorporate dual-band or tri-band capabilities, the newly developed MLO feature may enable packet-level link aggregation in the MAC layer across different PHY links. By performing load balancing according to traffic requirements, the MLO may achieve significantly higher throughput and lower latency for enhanced reliability in a heavily loaded network. With the MLO capability, a multi-link device (MLD) includes multiple affiliated devices to the upper logical link control (LLC) layer, allowing concurrent data transmission and reception in multiple channels across a single or multiple frequency bands in 2.4 GHz, 5 GHz and 6 GHz.

There exists Wi-Fi technologies that allow a Wi-Fi device to connect to a single link and enable the Wi-Fi device to switch among 2.4 GHz, 5 GHz and 6 GHz bands. However, such Wi-Fi devices typically have a switching overhead or delay of up to 100 ms. Therefore, the MLO is highly desirable for real-time applications like video calls, wireless VR headsets, cloud gaming and other latency-sensitive applications. The IEEE 802.11be draft specification defines different channel access methods according to two transmission modes: asynchronous and synchronous modes. Under asynchronous transmission mode, the MLD transmits frames asynchronously across multiple links without aligning the starting time. In contrast, in synchronous transmission mode, the starting times are aligned across the links. In either mode, the links may have their own primary channel and parameters, including Packet Protocol Data Unit (PPDU), Modulation and Coding Scheme (MCS), Enhanced Distributed Channel Access (EDCA), etc.

In existing Wi-Fi systems, there is a transmission opportunity (TXOP) sharing framework which enables the following. An AP may allocate time within an obtained TXOP to an associated STA. An STA that has been allocated time from the AP may transmit UL data without receiving a trigger frame from the AP during the allocated time or may communicate with other STAs within the same BSS through peer-to-peer communication. However, existing TXOP sharing only allows time resources to be allocated to one STA at a time, resulting in only one STA being able to use the channel during the allocated time, thereby reducing efficiency in terms of overall network traffic throughput.

The disclosure introduces a method to address the limitations of existing TXOP sharing by allowing APs to allocate time resources to multiple STAs simultaneously when TXOP sharing is operated, thereby enabling time-overlapped channel access. Furthermore, the disclosure also introduces a method for time-overlapped channel access by allocating time resources i) to multiple overlapping basic service set (OBSS) APs simultaneously or ii) to OBSS APs and STAs through multi-AP (MAP) coordination.

The technologies where multiple APs collaborate to exchange information about their networks and transmit and receive data with their BSS STAs and with OBSS STAs are important in next-generation Wi-Fi systems.

The disclosure expands TXOP sharing to MAP coordination. An AP may allocate TXOP to multiple STAs as well as adjacent APs simultaneously when the AP obtains TXOP. An AP may form a BSS by establishing associations with STAs, enabling data transmission and reception. There may be other APs operating in OBSSs (OBSS APs) around the AP, and the AP may coordinate with the OBSS APs. An AP controlling this coordination is referred to as a sharing AP and APs controlled by the sharing AP in this coordination are referred to as shared APs. The sharing AP and the shared APs form their own individual BSSs and communicate data with their associated STAs.

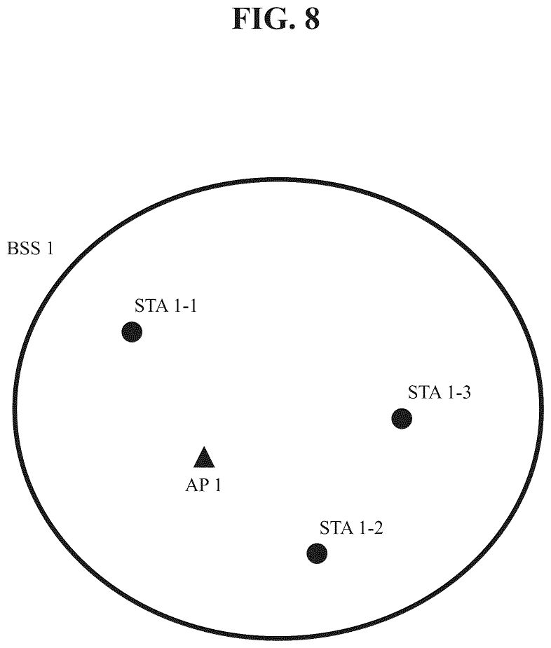

FIG. 8 shows an example BSS formed by an AP and its associated STAs in accordance with an embodiment. The BSS depicted in FIG. 8 is for explanatory and illustration purposes. FIG. 8 does not limit the scope of this disclosure to any particular implementation.

Referring to FIG. 8, AP 1 formed BSS 1 by establishing associations with STA 1-1, STA 1-2 and STA 1-3. AP 1 performs data transmissions and receptions with its associated STAs in BSS 1. AP 1 may be associated with more STAs within BSS 1.

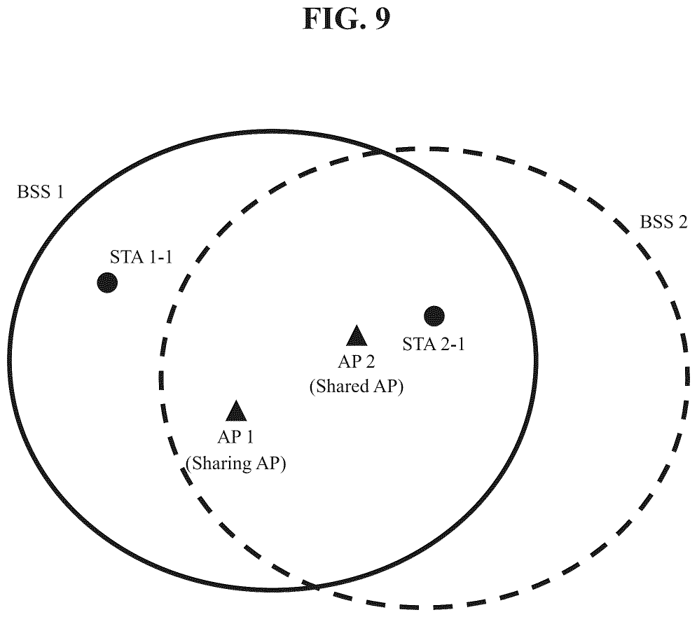

FIG. 9 shows an example BSS and OBSS formed by a sharing AP and its associated STA and a shared AP and its associated STA, respectively, in accordance with an embodiment. The BSS and OBSS depicted in FIG. 9 are for explanatory and illustration purposes. FIG. 9 does not limit the scope of this disclosure to any particular implementation.

Referring to FIG. 9, AP 1 formed BSS 1 with STA 1-1 and AP 2 formed BSS 2 with STA 2-1. AP 1 and AP 2 are engaged in MAP coordination with one another. AP 1 is the sharing AP that controls the MAP coordination, and AP 2 is the shared AP. AP 1 performs data transmissions and receptions with STA 1-1 and AP 2. There may be more than one shared AP. A STA may also be associated with more than one AP, for example STA 2-1 may also be associated with AP 1.

In an embodiment, an AP may share TXOP with multiple STAs simultaneously. When the AP shares TXOP with multiple STAs simultaneously, their transmissions need to avoid interfering with one another to ensure efficient operation. In order to prevent such interference, the AP may check for possible interference prior to allocating the time resources.

In an embodiment, an AP may identify non-interfering STA pairs based on a buffer status (the amount of traffic on an individual STA's buffer), the latency sensitivity of any traffic in the buffer, and the presence of interference. The AP may determine STAs for allocation of TXOP based on the factors listed above as discussed below.

In an embodiment, the AP may request the buffer status of STAs within its BSS. In an embodiment, the AP may allocate TXOP to STAs within its BSS based on which STAs have a high volume of traffic present on the STA's buffer according to the buffer status reported by the STA. In an embodiment, the AP may allocate TXOP to STAs within its BSS based on which STAs have a high volume of latency-sensitive traffic on the STA's buffer according to the buffer status reported by the STA. The AP may provide priority to low-latency (LL) traffic.

In an embodiment, after selecting STAs (candidate STAs) for TXOP sharing as described above, the AP may verify whether the candidate STAs do not interfere with each other during data transmission and reception.

In an embodiment, after identifying STAs that do not interfere with each other during data transmission and reception, the AP shares TXOP with them.

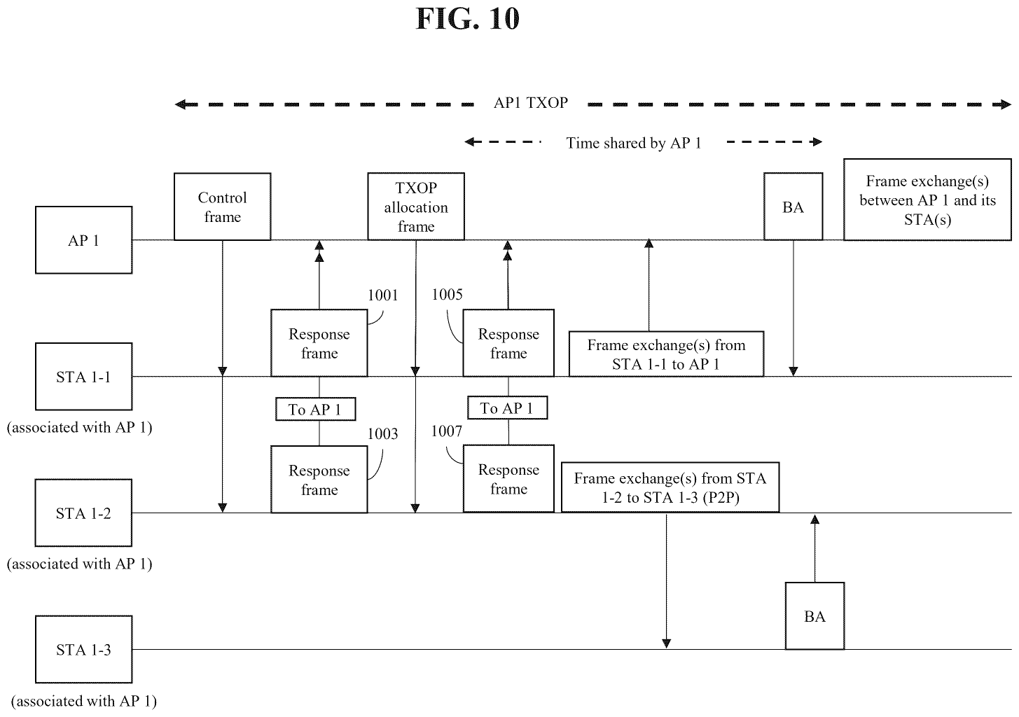

FIG. 10 shows an example TXOP sharing from the sharing AP with multiple STAs simultaneously in accordance with an embodiment. The TXOP sharing depicted in FIG. 10 is for explanatory and illustration purposes. FIG. 10 does not limit the scope of this disclosure to any particular implementation.

Referring to FIG. 10, AP 1 is associated with STA 1-1, STA 1-2 and STA 1-3. AP 1 obtains TXOP on a wireless medium. Subsequently, AP 1 transmits, to STA 1-1 and STA 1-2, a control frame requesting that each STA provides AP 1 with its buffer status and the presence of latency-sensitive traffic. In an implementation, the control frame may be a multi-user request-to-send (MU-RTS) trigger frame. The MU-RTS trigger frame can protect the TXOP by allowing recipient STAs to use the MU-RTS trigger frame to update their network allocation vector (NAV) setting.

In response, STA 1-1 and STA 1-2 assess their buffer status and the presence of latency-sensitive traffic. Subsequently, STA 1-1 transmits, to AP 1, a response frame 1001 indicating the STA's buffer status and the presence of latency-sensitive traffic. STA 1-2 transmits, to AP 1, a response frame 1003 indicating the STA's buffer status and the presence of latency-sensitive traffic. Each response frame may also inform AP1 about the destination device of data transmissions. In this example, the response frame 1001 indicates that STA 1-1 intends to transmit data to AP 1. In the same example, the response frame 1003 indicates that STA 1-2 intends to transmit data to STA 1-3. In an implementation, the response frames may be clear-to-send (CTS) frames. The response frames can protect the TXOP by allowing recipient STAs to use the response frame to update their NAV setting. In an embodiment, a variant of CTS frame can be used to provide buffer status and other information.

Subsequently, upon receiving the response frame 1001 and the response frame 1003, AP 1 determines whether there is interference between STA 1-1's data transmission and STA 1-2's data transmission when both data transmissions are performed simultaneously. If AP 1 determines that there is no interference between STA 1-1's data transmission and STA 1-2's data transmission, then AP 1 may allocate TXOP to STA 1-1 and STA 1-2. Thus, AP 1 may determine to allocate TXOP to STA 1-1 and STA 1-2 based on the buffer status, the presence of latency-sensitive traffic and whether there is interference between the simultaneous transmissions. AP 1 transmits, to STA 1-1 and STA 1-2, a TXOP allocation frame allocating a portion of AP 1's TXOP. The TXOP allocation frame may be a MU-RTS triggered TXOP sharing (TXS) trigger frame.

In response, STA 1-1 transmits, to AP 1, a response frame 1005 indicating that STA 1-1 is able to participate in the transmission of traffic using the allocated TXOP. Subsequently, STA 1-1 performs frame exchanges with AP 1. STA 1-2 transmits, to AP 1, a response frame 1007 indicating that STA 1-2 is able to participate in the transmission of traffic using the allocated TXOP. Subsequently, STA 1-2 performs frame exchanges with STA 1-3, which is a peer-to-peer (P2P) communication between STA 1-2 and STA 1-3.

In response, AP 1 transmits, to STA 1-1, a block acknowledgement (BA) in response to receiving frames from STA 1-1. AP 1 may use the remainder of its TXOP to perform transmissions and receptions with STAs in its BSS. STA 1-3 transmits, to STA 1-2, a BA in response to receiving frames from STA 1-2.

In an embodiment, an AP may perform the processes shown in FIG. 10 with additional STAs. The determination of whether to allocate TXOP to a STA, a candidate STA, may be based on the buffer status and the presence of latency-sensitive traffic reported by the STAs.

In an embodiment, an AP may determine a selection of STAs from the candidate STAs with minimal or manageable interference for which to allocate TXOP. The AP may determine the selection of STAs based on a received signal strength indicator (RSSI) measurement of each candidate STA. The AP determines the selection of STAs based on RSSI measurement by measuring the signal strength of each candidate STA and excluding STAs with excessive signal overlap. In an embodiment, the AP may determine the selection of STAs from candidate STAs that are spatially separated and have minimal interference. In an embodiment, the AP may determine the selection of STAs based on a signal-to-interference-plus-noise ratio (SINR) analysis. The AP determines the selection of STAs based on SINR analysis by evaluating the level of signal interference among STAs while a specific STA is using TXOP. Subsequently the AP avoids assigning TXOP to STAs that the AP has previously allocated TXOP to and that the AP evaluated the level of signal interference among STAs as being too low during the previous allocation. The AP ensures that interference remains within an acceptable range by avoiding allocating TXOP to such STAs.

In an embodiment, an AP may control STAs that it has allocated TXOP to perform transmissions using the TXOP as described below to minimize interference. In an embodiment, the AP may instruct the STAs to apply multi-user (MU)-multiple input multiple output (MIMO) methods when performing their transmissions. The STAs apply MU-MIMO methods by using multiple antennas and beamforming techniques to prevent interference with other STAs' traffic transmissions. In an embodiment, the AP may apply STA Location-Based Allocation methods when allocating TXOP to the STAs. The AP applies STA Location-Based Allocation methods by not permitting STAs that are physically close to each other to perform transmissions using allocated TXOP simultaneously and only permitting STAs that are sufficiently separated in distance or have tolerable interference levels to perform transmissions using allocated TXOP. In an embodiment, the AP may use transmit power adjustment methods when STAs are performing their transmission using TXOP allocated by the AP. The AP may use transmit power adjustment methods by controlling the transmission power of each STA to limit signal range and keep interference within an acceptable threshold. For example, the AP may instruct STAs performing P2P communication to use lower power or direct STAs that are in close proximity within the TXOP sharing group to reduce their transmission power, ensuring interference remains at a manageable level.

In an embodiment, an AP (sharing AP) may share TXOP with multiple STAs and OBSS APs (shared AP) simultaneously using MAP coordination. When the AP shares TXOP with multiple STAs and shared APs simultaneously, their transmissions need to avoid interfering with one another to ensure efficient operation. In order to prevent such interference, the AP may check for possible interference prior to allocating the time resources. The AP may identify which STAs and shared APs do not interfere with each other prior to the allocation of the TXOP as discussed below.

In an embodiment, a sharing AP may recognize the buffer status of STAs within its BSS and shared APs with which it coordinates. In an embodiment, the sharing AP may allocate TXOP to STAs within its BSS based on which STAs have a high volume of traffic present on the STA's buffer according to the buffer status reported by the STA. The sharing AP may allocate TXOP to shared APs based on which shared APs have a high volume of traffic present on the shared AP's buffer according to the buffer status reported by the shared AP. In an embodiment, the sharing AP may allocate TXOP to STAs within its BSS based on which STAs have a high volume of latency-sensitive traffic on the STA's buffer according to the buffer status reported by the STA. The sharing AP may allocate TXOP to shared APs based on which shared APs have a high volume of latency-sensitive traffic on the shared AP's buffer according to the buffer status reported by the STA. The AP may provide priority to latency-sensitive traffic, such as low-latency traffic.

In an embodiment, the sharing AP verifies whether the STAs and shared APs (candidate STAs and shared APs) interfere with one another when transmitting and receiving data simultaneously. The candidate STAs and shared APs are determined as described above based on the buffer status associated with that STA or shared AP and the presence of latency-sensitive traffic among the STAs or shared APs.

In an embodiment, the sharing AP allocates TXOP to candidate STAs and shared APs that the sharing AP determined did not interfere with each other when transmitting and receiving data simultaneously.

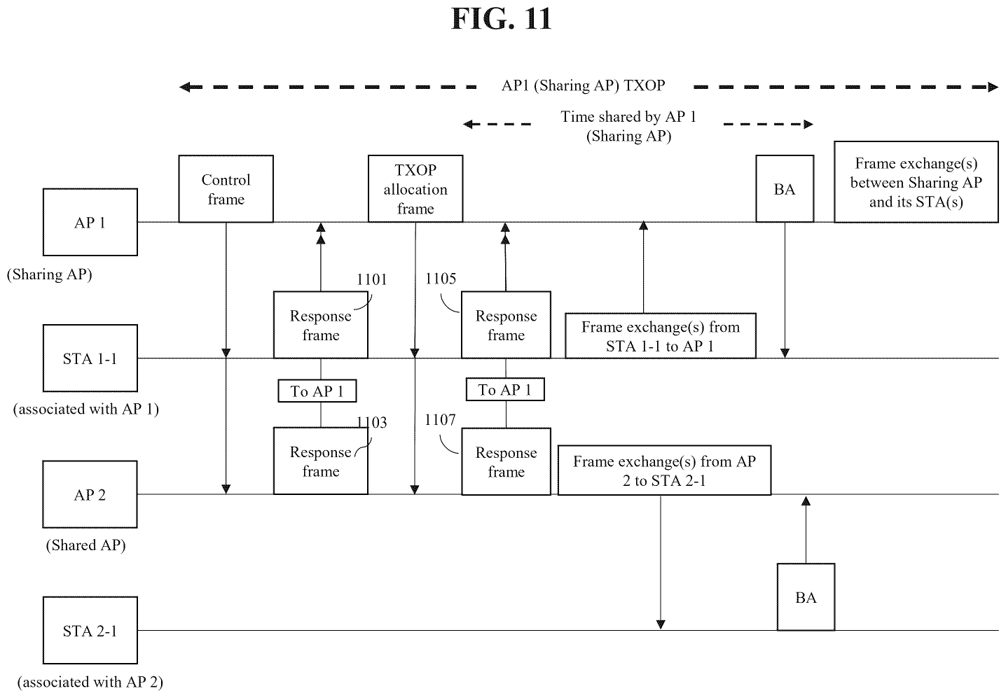

FIG. 11 shows an example TXOP sharing from the sharing AP with a STA in the sharing AP's BSS and a shared AP in accordance with an embodiment. The TXOP sharing depicted in FIG. 11 is for explanatory and illustration purposes. FIG. 11 does not limit the scope of this disclosure to any particular implementation.

Referring to FIG. 11, AP 1 is associated with STA 1-1 and AP 2 is associated with STA 2-1. AP 1 and AP2 are engaged in MAP coordination with one another where AP 1 is the sharing AP and AP 2 is the shared AP. AP 1 obtains TXOP on a wireless medium. Subsequently, AP 1 transmits, to STA 1-1 and AP 2, a control frame requesting that the STA or AP provides AP 1 with its buffer status and the presence of latency-sensitive traffic. The control frame may be a MU-RTS trigger frame. The MU-RTS trigger frame can protect the TXOP by allowing recipient STAs to use the MU-RTS trigger frame to update their NAV setting.

In response, STA 1-1 and AP 2 assess their buffer status and the presence of latency-sensitive traffic. Subsequently, STA 1-1 transmits, to AP 1, a response frame 1101 indicating STA 1-1's buffer status and the presence of latency-sensitive traffic. AP 2 transmits, to AP1, a response frame 1103 indicating AP 2's buffer status and the presence of latency-sensitive traffic. Each response frame may also inform AP1 about the destination device of data transmissions. In this example the response frame 1101 indicates that STA 1-1 intends to transmit data to AP 1. In the same example, the response frame 1103 indicates that AP 2 intends to transmit data to STA 2-1. In an implementation, the response frames may be clear-to-send (CTS) frames. The response frames can protect the TXOP by allowing recipient STAs to use the response frame to update their NAV setting. In an embodiment, a variant of CTS frame can be used to provide buffer status and other information.

Subsequently, upon receiving the response frame 1101 and the response frame 1103, AP 1 determines whether there is interference between STA 1-1's data transmission and AP 2's data transmission when both data transmissions are performed simultaneously. If AP 1 determines that there is no interference between STA 1-1 data transmission and AP 2's data transmission, then AP 1 may allocate TXOP to STA 1-1 and AP 2. Thus, AP 1 may determine to allocate TXOP to STA 1-1 and AP 2 based on the buffer status, the presence of latency-sensitive traffic and whether there is interference between the simultaneous transmissions. AP 1 transmits, to STA 1-1 and AP 2, a TXOP allocation frame allocating a portion of AP 1's TXOP. The TXOP allocation frame may be a MU-RTS TXS trigger frame.

In response, STA 1-1 transmits, to AP 1, a response frame 1105 indicating that STA 1-1 is able to participate in the transmission of traffic using the allocated TXOP. Subsequently, STA 1-1 performs frame exchanges with AP 1. AP 2 transmits, to AP 1, a response frame 1107 indicating that AP 2 is able to participate in the transmission of traffic using the allocated TXOP. Subsequently, AP 2 performs frame exchanges with STA 2-1.

In response, AP 1 transmits, to STA 1-1, a BA. AP 1 may use the remainder of its TXOP to perform transmissions and receptions for its BSS. STA 2-1 transmits, to AP 2, a BA.

In an embodiment, an AP may perform the processes shown in FIG. 11 with additional STAs and OBSS APs. The determination of whether to allocate TXOP to a STA or an OBSS AP, a candidate STA or AP, may be based on the buffer status and the presence of latency-sensitive traffic. In an embodiment, an AP may perform the processes shown in FIG. 11 where instead of STA 1-1 and AP 2 (STAs and APs) there are only APs. In that case STA 1-1 would be replaced by an AP, such as AP 3, and the AP, AP 1, would allocate TXOP to AP 2 and AP 3.

In an embodiment, an AP may determine a selection of STAs and APs from candidate STAs and APs with minimal or manageable interference for which to allocate TXOP. The AP may determine the selection of STAs and APs based on a RSSI measurement of each candidate STA and AP. The AP determines the selection of STAs and APs based on the RSSI measurement by measuring the signal strength of each candidate STA and AP and excluding STAs and APs with excessive signal overlap. In an embodiment, the AP may determine the selection of STAs and APs from candidate STAs and APs that are spatially separated and have minimal interference. In an embodiment, the AP may determine the selection of STAs and APs based on a SINR analysis. The AP determines the selection of STAs based on SINR analysis by evaluating the level of signal interference among STAs and APs while a specific STA or AP is using TXOP. Subsequently, the AP avoids assigning TXOP to STAs or APs that the AP has previously allocated TXOP to and that the AP evaluated the level of signal interference among STAs and APs as being too low during the previous allocation. The AP ensures that interference remains within an acceptable range by avoiding allocating TXOP to such STAs and APs.

In an embodiment, an AP may control candidate STAs and APs (STAs and APs) that it has allocated TXOP to perform transmissions using the TXOP as described below to minimize interference. In an embodiment, the AP may instruct the STAs and APs to apply MU-MIMO methods when performing their transmissions. The STAs and APs apply MU-MIMO methods by using multiple antennas and beamforming techniques to prevent interference with other STAs and APs' traffic transmissions. In an embodiment, the AP may apply STA and AP Location-Based Allocation methods when allocating TXOP to the STAs and APs. The AP applies STA Location-Based Allocation methods by not permitting STAs and APs that are physically close to each other to perform transmission using allocated TXOP simultaneously and only permitting STAs and APs that are sufficiently separated in distance or have tolerable interference levels to perform transmissions using allocated TXOP simultaneously. In an embodiment, the AP may use transmit power adjustment methods when STAs are performing their transmission using TXOP allocated by the AP. The AP may use transmit power adjustment methods by controlling the transmission power of each STA and AP to limit signal range and keep interference within an acceptable threshold. For example, the AP may instruct STAs performing P2P communication to use lower power or direct STAs or APs that are in close proximity within the TXOP sharing group to reduce their transmission power, ensuring interference remains at a manageable level.

In an embodiment, an AP may determine a selection of APs, in the case where there are only multiple APs, in the same manner described above to ensure minimum interference with simultaneous transmissions of multiple APs.

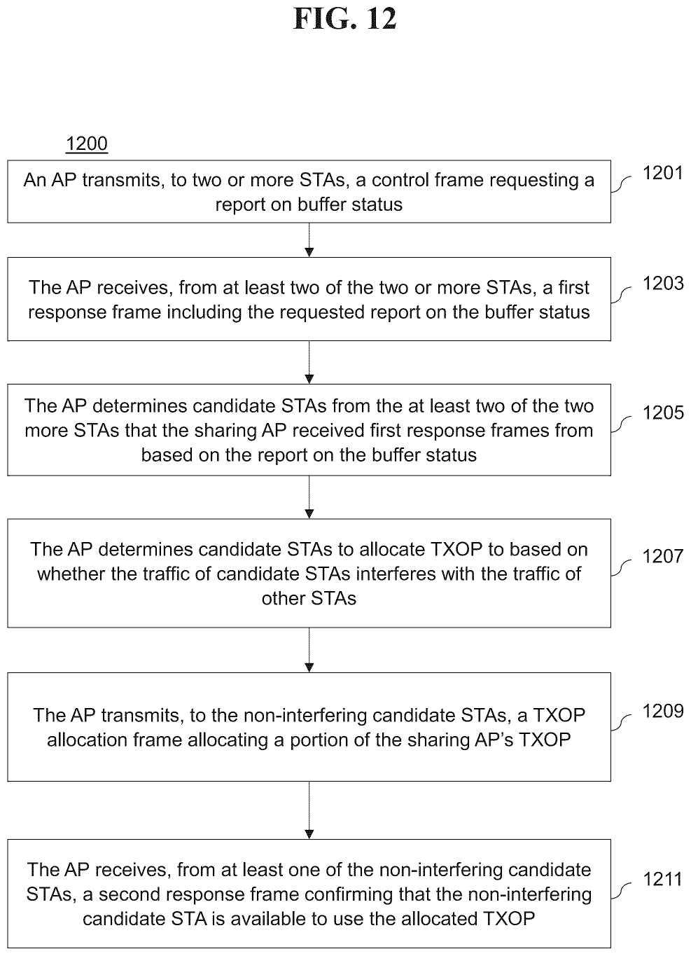

FIG. 12 shows an example TXOP sharing process for allocating time resources in accordance with an embodiment. This example may be performed by an AP. The TXOP sharing process depicted in FIG. 12 is for explanatory and illustration purposes. FIG. 12 does not limit the scope of this disclosure to any particular implementation.

Referring to FIG. 12, the process 1200 begins at operation 1201. In operation 1201, an AP transmits, to two or more STAs in its BSS, a control frame requesting a report on buffer status. The AP may also transmit the control frame to OBSS APs (APs). The AP may transmit control frames to one or more STAs in its BSS and one or more APs. The AP may transmit control frames to two or more APs. The control frame may request an indication of the presence of latency-sensitive traffic.

In operation 1203, the AP receives, from at least two of the two or more STAs, a first response frame including the requested report on the buffer status. The first response frame may include an indication of the presence of latency-sensitive traffic if the control frame had included the request for an indication of the presence of latency-sensitive traffic. The first response frame may include information indicating the destination device of the transmission.

In operation 1205, the AP determines candidate STAs from the at least two of the two or more STAs that the AP received first response frames based on the report on the buffer status. The AP may make its determination also based on the presence of latency-sensitive traffic. The AP weighs candidates STAs more highly when that STA's buffer status indicates high volume of traffic, or when the STA has latency-sensitive traffic.

In operation 1207, the AP determines candidate STAs to allocate TXOP to based on whether the traffic of candidate STAs interferes with the traffic of other STAs. Interference may occur where two traffics overlap in time on a channel. The AP may determine to allocate TXOP to a candidate STA that interferes with the traffic of other STAs if the interference is minimal or manageable. Interference is minimal or manageable when other transmissions can still be performed without issue. The AP may determine if the interference is minimal or manageable based on RSSI measurement or SINR analysis methods. The AP may control STAs to minimize interference with traffic.

In operation 1209, the AP transmits, to the non-interfering candidate STAs, a TXOP allocation frame allocation a portion of the sharing AP's TXOP.

In operation 1211, the AP receives, from at least one of the non-interfering candidate STAs, a second response frame confirming that the non-interfering candidate STA is available to use the allocated TXOP.

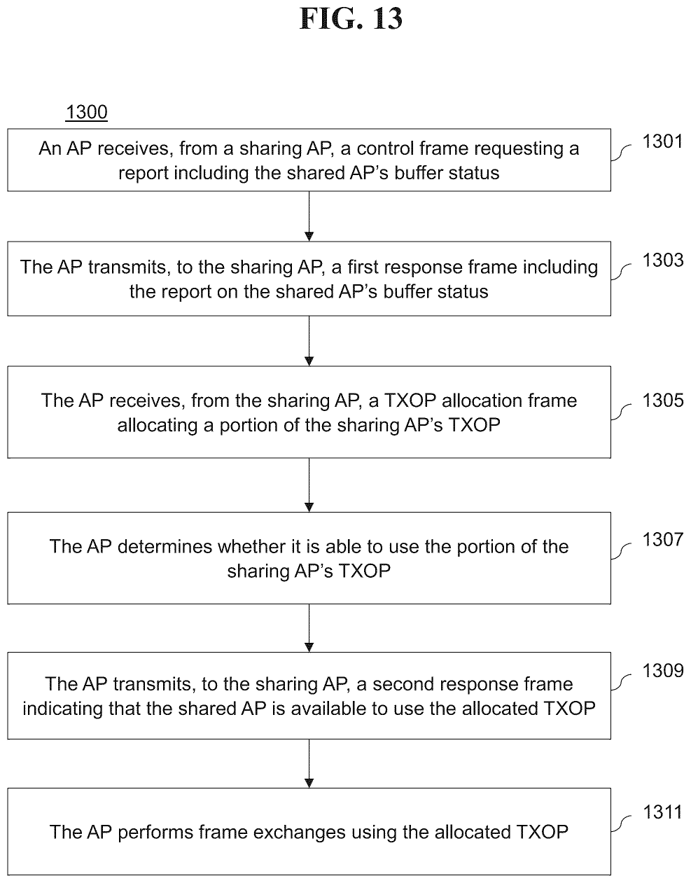

FIG. 13 shows another example TXOP sharing process for allocating time resources in accordance with an embodiment. This example may be performed by an AP. The TXOP sharing process depicted in FIG. 13 is for explanatory and illustration purposes. FIG. 13 does not limit the scope of this disclosure to any particular implementation.

Referring to FIG. 13, the process 1300 begins at operation 1301. In operation 1301, a first AP receives, from a second AP, a control frame requesting a report including the first AP's buffer status. The control frame may request an indication of the presence of latency-sensitive traffic.

In operation 1303, the first AP transmits, to the second AP, a first response frame including the report on the first AP's buffer status. The first response frame may include an indication of the presence of latency-sensitive traffic if the control frame included a request for an indication of the presence of latency-sensitive traffic.

In operation 1305, the first AP receives, from the second AP, a TXOP allocation frame allocating a portion of the second AP's TXOP.

In operation 1307, the first AP determines whether it is able to use the portion of the second AP's TXOP.

In operation 1309, the first AP transmits, to the second AP, a second response frame indicating that the first AP is available to use the allocated TXOP based on the first AP's determination of its ability to use the portion of the TXOP.

In operation 1311, the first AP performs frame exchanges using the allocated TXOP. The frame exchanges may be with the second AP or with STAs associated with the first AP.

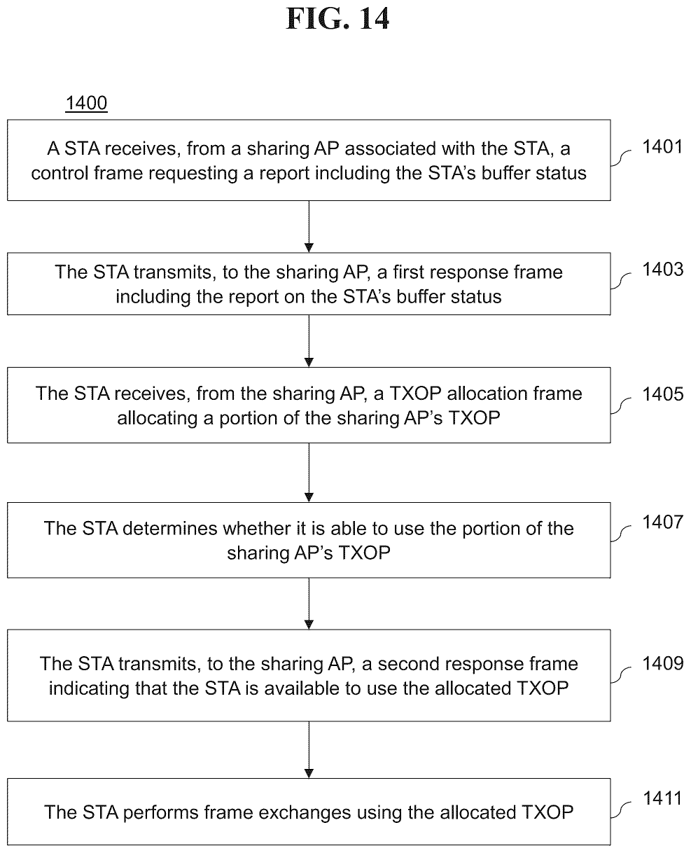

FIG. 14 shows an example TXOP sharing process for allocating time resources in accordance with an embodiment. This example may be performed by an STA. The TXOP sharing process depicted in FIG. 14 is for explanatory and illustration purposes. FIG. 14 does not limit the scope of this disclosure to any particular implementation.

Referring to FIG. 14, the process 1400 begins at operation 1401. In operation 1401, a STA receives, from an AP associated with the STA, a control frame requesting a report including the STA's buffer status. The control frame may request an indication of the presence of latency-sensitive traffic.

In operation 1403, the STA transmits, to the AP, a first response frame including the report on the STA's buffer status. The first response frame may include an indication of the presence of latency-sensitive traffic if the control frame included a request for an indication of the presence of latency-sensitive traffic.

In operation 1405, the STA receives, from the AP, a TXOP allocation frame allocating a portion of the AP's TXOP.

In operation 1407, the STA determines whether it is able to use the portion of the AP's TXOP.

In operation 1409, the STA transmits, to the AP, a second response frame indicating that the STA is available to use the allocated TXOP.

In operation 1411, the STA performs frame exchanges using the allocated TXOP.

The disclosure provides mechanisms and procedures for TXOP sharing to perform time-overlapped channel access where the mechanisms and procedure improve the efficiency of TXOP sharing allowing for an AP to avoid allocating TXOP to multiple STAs and APs whose transmissions may interfere with each other's.

The various illustrative blocks, units, modules, components, methods, operations, instructions, items, and algorithms may be implemented or performed with processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, the description may provide illustrative examples and the various features may be grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The embodiments are provided solely as examples for understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first access point (AP) for facilitating communication in a wireless network, comprising:
a memory;
a processor coupled to the memory, the processor configured to cause:
obtaining a transmission opportunity (TXOP) on a wireless channel;
transmitting, to a plurality of stations (STAs), a control frame that requests buffer status information;
receiving, from at least two STAs, response frames, each response frame including a buffer status report associated with a respective STA;
determining two or more candidate STAs for allocation of a portion of the TXOP based on the buffer status report in each response frame;
determining whether estimated interference between the two or more candidate STAs is smaller than a predetermined level; and
transmitting, to the two or more candidate STAs, a frame that allocates a portion of the obtained TXOP based on a determination that the estimated interference is smaller than the predetermined level.

2. The first AP of claim 1, wherein:
the control frame further requests information associated with a presence of latency-sensitive traffic;
each response frame further includes an indication of the presence of latency-sensitive traffic; and
the two or more candidate STAs are determined based on the buffer status report and the presence of latency-sensitive traffic in each response frame.

3. The first AP of claim 2, wherein the determining two or more candidate STAs comprising prioritizing a STA having latency-sensitive traffic.

4. The first AP of claim 1, wherein the determining two or more candidate STAs comprising prioritizing a STA having a large volume of traffic in a buffer.

5. The first AP of claim 1, wherein each response frame includes information about a destination STA of traffic stored in the buffer.

6. The first AP of claim 1, wherein each of the two or more second STAs is either a non-AP STA or an AP.

7. The first AP of claim 6, wherein:
the two or more candidate STAs include one or more second APs;
the first AP and the one or more second APs participate in a multi-AP coordination; and
the first AP is a sharing AP and the one or more second APs are sharing APs.

8. The first AP of claim 1, wherein the two or more candidate STAs are determined based on the estimated interference and an interference condition.

9. The first AP of claim 8, wherein the interference condition includes at least one of signal strength, relative position or previous interference level of each candidate STA.

10. The first AP of claim 1, wherein the two or more candidate STAs are allowed to simultaneously transmit and receive one or more frames during the allocated TXOP.

11. A method performed by an access point, the method comprising:
obtaining a transmission opportunity (TXOP) on a wireless channel;
transmitting, to a plurality of stations (STAs), a control frame that requests buffer status information;
receiving, from at least two STAs, response frames, each response frame including a buffer status report associated with a respective STA;
determining two or more candidate STAs for allocation of a portion of the TXOP based on the buffer status report in each response frame;
determining whether estimated interference between the two or more candidate STAs is smaller than a predetermined level; and
transmitting, to the two or more candidate STAs, a frame that allocates a portion of the obtained TXOP based on a determination that the estimated interference is smaller than the predetermined level.

12. The method of claim 11, wherein:
the control frame further requests information associated with a presence of latency-sensitive traffic;
each response frame further includes an indication of the presence of latency-sensitive traffic; and
the two or more candidate STAs are determined based on the buffer status report and the presence of latency-sensitive traffic in each response frame.

13. The method of claim 12, wherein the determining two or more candidate STAs comprising prioritizing a STA having latency-sensitive traffic.

14. The method of claim 11, wherein the determining two or more candidate STAs comprising prioritizing a STA having a large volume of traffic in a buffer.

15. The method of claim 11, wherein each response frame includes information about a destination STA of traffic stored in the buffer.

16. The method of claim 11, wherein each of the two or more second STAs is either a non-AP STA or an AP.

17. The method of claim 16, wherein:
the two or more candidate STAs include one or more second APs;
the first AP and the one or more second APs participate in a multi-AP coordination; and
the first AP is a sharing AP and the one or more second APs are sharing APs.

18. The method of claim 11, wherein the two or more candidate STAs are determined based on the estimated interference and an interference condition.

19. The method of claim 18, wherein the interference condition includes at least one of signal strength, relative position or previous interference level of each candidate STA.

20. The method of claim 11, wherein the two or more candidate STAs are allowed to simultaneously transmit and receive one or more frames during the allocated TXOP.
